(19) United States
(12) Patent Application Publication
(10) Pub. No.: US 2011/0144857 A1
(43) Pub. Date: Jun. 16, 2011

(54) ANTICIPATORY AND ADAPTIVE AUTOMOBILE HMI

(76) Inventors: Theodore Charles Wingrove, Canton, MI (US); Michael Dean Tschirhart, Ann Arbor, MI (US); Anthony Ciatti, Ann Arbor, MI (US)

(21) Appl. No.: 12/637,266

(22) Filed: Dec. 14, 2009

(51) Int. Cl. G06F 7/00

(52) U.S. Cl. 701/33; 701/29

(57) ABSTRACT

An anticipatory and adaptive human machine interface control system for an automobile and a method for adaptively modifying an information display in an automobile are disclosed, wherein the control system and method control the information displayed in response to a vehicle information signal. The adaptive human machine interface control system for a vehicle includes a vehicle information system adapted to generate and transmit a vehicle information signal including data representing a vehicle condition and a controller adapted to receive and analyze the vehicle information signal. The controller generates and transmits a control signal for controlling a visual representation of data in response to the vehicle information signal.

### FIELD OF THE INVENTION

The present invention relates to a human machine interface. More particularly, the invention is directed to a human machine interface control system for a vehicle and a method for controlling a display of information based on sensed or received data.

### BACKGROUND OF THE INVENTION

A human machine interface (“HMI”) within a motor vehicle generally refers to the interaction of a user with an information display. Flat screen TFT, LCD and LED information displays are rapidly becoming cost effective to implement within vehicles, and as price decreases, the size of the display may be increased. Such displays allow for increased information to be available to a user of the display. Two essential functions of the center stack are to inform passengers of the general state of the vehicle and to permit passengers to adjust accessories influencing passenger comfort such as temperature and radio volume, for example. Typically, current center stacks include at least one digital display. The digital display is usually a flat, rectangular, thin film transistor (TFT) glass display or a liquid crystal display (LCD). Optionally, the display can include a touch screen overlay or can be controlled by a large number of switches. Also, the size and complexity of the displays allows for the display of complex information. It is known to program differing display characteristics, such as color and information displayed, based on an operating characteristic of the motor vehicle, such as speed or direction travelled.

However, in today's vehicles, there is no provision for dynamically adapting a vehicles user interface to its current operating conditions. Certain functions or information displayed that are appropriate to one set of operating conditions, such as at lower speeds and/or under non-threatening driving conditions, might not be appropriate for higher speeds and more threatening driving conditions.

Accordingly, it would be desirable to produce a system capable of determining based upon available data an appropriate display for a user of the display.

### SUMMARY OF THE INVENTION

Concordant and consistent with the present invention, an anticipatory and adaptive human machine interface control system for an automobile and a method for adaptively modifying an information display in an automobile, wherein the control system and method control the information displayed in response to a vehicle information signal, has surprisingly been discovered.

In one embodiment, an adaptive human machine interface control system for a vehicle comprises a vehicle information system adapted to generate and transmit a vehicle information signal including data representing a vehicle condition; and a controller adapted to receive the vehicle information signal, analyze the vehicle information signal, and generate and transmit a control signal for controlling a visual representation of data in response to the vehicle information signal.

In another embodiment, an adaptive human machine interface control system for a vehicle comprises a vehicle information system adapted to generate and transmit a vehicle information signal including data representing a vehicle condition; a controller adapted to receive the vehicle information signal, analyze the vehicle information signal, and generate and transmit a control signal in response to the vehicle information signal, and a display adapted to receive the control signal and generate a visual display of data in response to the control signal.

The invention also provides methods for controlling a display of information.

One method comprises the steps of: retrieving data representing at least one condition; generating a vehicle information signal including first data representing at least one condition; analyzing the vehicle information signal; generating a control signal in response to the vehicle information signal; and generating a visual representation of second data on a display in response to the control signal.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings, in which:

FIG. 1. is a schematic block diagram of an adaptive HMI control system according to an embodiment of the present invention; and

FIGS. 2a and 2b are schematic representations of example displays according to an embodiment of the invention.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

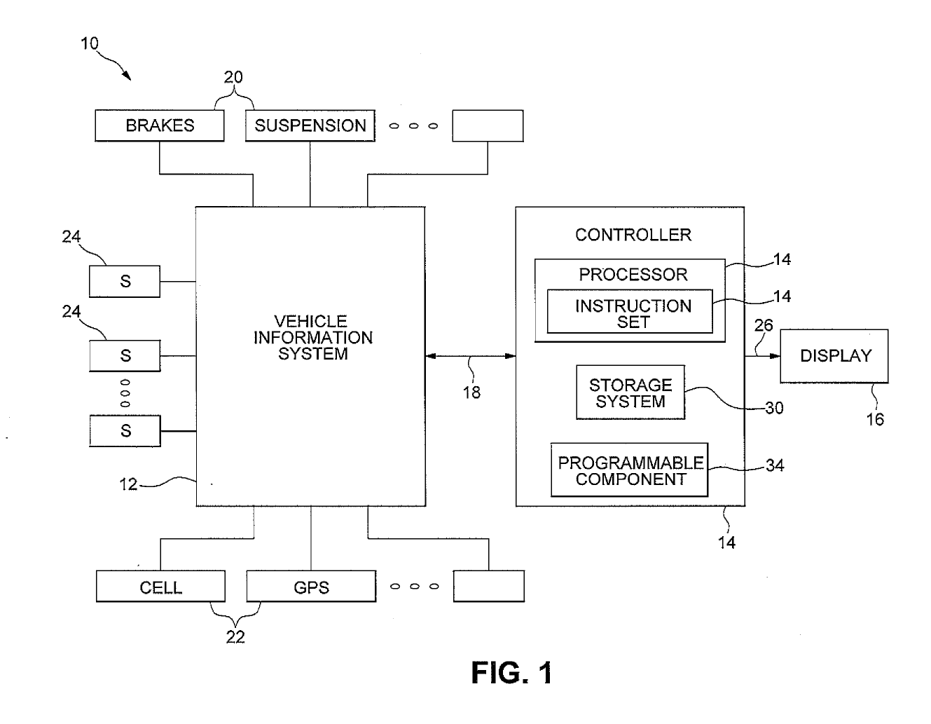

Referring to FIG. 1, an adaptive human machine interface (“HMI”) control system 10 is shown according to the present invention. The adaptive control system 10 includes a vehicle information system 12, a controller 14, and a display 16. It is understood that the adaptive HMI control system 10 may be installed in a vehicle during original manufacture of the vehicle, or it may be subsequently added in a post-production or aftermarket operation. The display 16 may be any display within the vehicle, and is contemplated for use in center stack electronics such as climate controls or global positioning systems, in vehicle entertainment systems such as front or rear seat audio/infotainment displays, or in driver information displays such as instrument clusters and head-up displays.

The vehicle information system 12 is adapted to transmit a vehicle information signal 18 to the controller 14. The vehicle information signal 18 may include data from a plurality of on-board vehicle systems 20 such as a suspension system, a vehicular stability system, a braking system, a tire pressure monitoring system, an engine control unit, a speedometer, a tachometer, a radio, and an electronic window control system and the like, for example. Additionally, the vehicle information signal 18 may include data received from a plurality of off-board systems 22, such as cell phone, traffic, GPS, weather signals and the like, for example. The vehicle information signal 18 may include only on-board vehicle system data, only off-board system data, or a combination thereof, as desired.

The vehicle information system 12 may additionally include a plurality of sensors 24 that directly measure a particular condition, either on-board or off-board, and transmit a signal representative of the measured condition to the vehicle information system 12. The vehicle information system 12 may receive the representative signal directly from each sensor 24, or the vehicle information system 12 may receive a signal representative of a measured condition from a secondary vehicle system (not shown), wherein the vehicle information system 12 is adapted to retrieve a desired data from the secondary vehicle system. As a non-limiting example, the vehicle may include an electronic module that measures the activity of the vehicle stability control. The vehicle information system 12 may receive the stability control data measured either directly by a sensor 24, or it may receive stability control data as transmitted data from the electronic module. Likewise, the off-board information may be derived from a sensor, such as an external temperature sensor, or it may be derived from an off-board system, such as a weather reporting system.

The controller 14 is adapted to receive the vehicle information signal 18, analyze the vehicle information signal 18, and transmit a control signal 26 to the display 16 in response to an analysis of the vehicle information signal 18. The controller 14 may be any device adapted to receive the vehicle information signal 18, analyze the vehicle information signal 18, and transmit the control signal 26. The controller 14 may also include analysis software, as appropriate.

In one embodiment, the controller 14 includes a processor 28 and a storage system 30. The processor 28 is adapted to analyze the vehicle information signal 18 based upon an instruction set 32. The instruction set 32, which may be embodied within any computer readable medium, includes processor executable instructions for configuring the processor 28 to perform a variety of tasks. The storage system 30 may be a single storage device or may be multiple storage devices. Portions of the storage system 30 may also be located on the processor 28. Furthermore, the storage system 30 may be a solid state storage system, a magnetic storage system, an optical storage system or any other suitable storage system. It is understood that the storage system 30 is adapted to store the instruction set 32. Other data may be stored in the storage system 30, as desired.

The controller 14 may further include a programmable component 34 in communication with the processor 28. It is understood that the programmable component 34 may be in communication with any other component of the adaptive HMI control system 10 such as the vehicle information system 12 and the storage system 30, for example. In certain embodiments, the programmable component 34 is adapted to manage and control processing functions of the processor 28. Specifically, the programmable component 34 is adapted to control the analysis of the vehicle information signal 18 and the generation and transmission of the control signal 26. The programmable component 34 provides a means for a user to actively manage the operation of the processor 28 and thereby control the resultant display adaptation effect generated by the display 16. It is understood that the programmable component 34 may be adapted to manage and control the vehicle information system 12. It is further understood that the programmable component 34 may be adapted to store data on the storage system 30 and retrieve data from the storage system 30.

In use, the vehicle information system 12 transmits the vehicle information signal 18 to the controller 14. As a non-limiting example, the vehicle information signal 18 may include data representing the vehicle windshield wiper system. Specifically, the vehicle information signal 18 may include data representing that the vehicle is traveling through precipitation, as evident by an increase in windshield wiper activity. Further, the vehicle information signal may include data representing that the ambient outside temperature is below 32° F. (0° C.). In combination, this data may be interpreted by the controller 14 as snow, ice or other difficult driving conditions. It is understood that the vehicle information signal 18 may include data relating to any on-board vehicle system such as a braking system, a speedometer, a tachometer, a radio, and an electronic window control system, for example, as well as any off-board vehicle system such as GPS, cell data, weather, traffic and the like.

The controller 14 receives the vehicle information signal 18 and analyzes the vehicle information signal 18. In one embodiment, the processor 28 analyzes the vehicle information signal 18 based upon the pre-programmed instruction set 32. It is understood that the instruction set 32 may be fixed by the manufacturer, or it may be altered by the user, thereby modifying the desired analysis of the vehicle information signal 18 and the generation of the resultant control signal 26. It is further understood that the user may configure the processor 28 and the instruction set 32 through the programmable component 34. Once the vehicle information signal 18 is analyzed, the controller 14 transmits a control signal 26 to the display 16. The control signal 20 includes data for adapting the display 16 to the prevalent driving conditions, as interpreted by the processor 28, controlling the visual representation of data on the display 16.

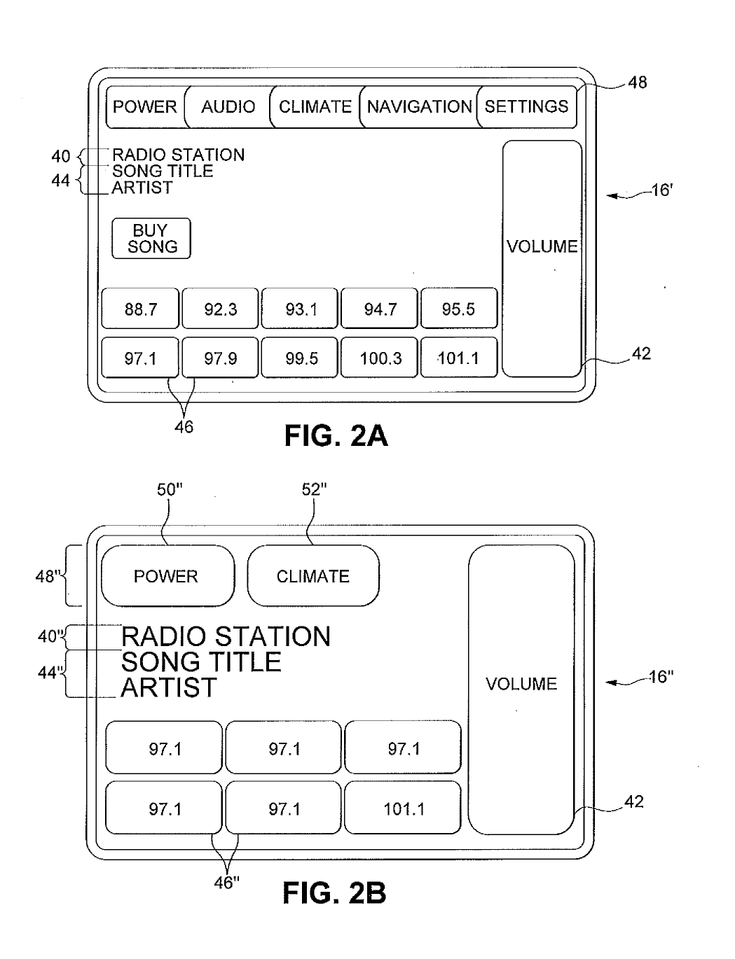

An example visual representation of data on a display 16′ is shown in FIG. 2a. In this example, the display 16′ is configured to display audio and/or infotainment information. As a non-limiting example, the visual representation of information on the display 16′ may occur during non-challenging driving conditions. Under such conditions, the display 16′ may include a significant amount of information, such as current station 40, volume level 42, artist and song data 44, a large number of relatively small station preset buttons 46, and an option bar 48 to switch the display to control different functions, such as to a climate-control or navigation modes.

As driving conditions become more complex or difficult, such as during the aforementioned precipitation below a freezing temperature, the visual representation of the information on the display 16′ may change, as represented by the display 16″ of FIG. 2b to show less information in a format that is easier for the driver to evaluate. By way of example, fewer and larger station preset buttons 46″ are presented to the driver, potentially indicative of those station preset buttons 46″ most commonly utilized by the driver. Additionally, the volume level 42″, the radio station 40″, and the artist and song data 44″ is enlarged, making evaluation of each by the driver easier and less distracting. Finally, the option bar 48″ has been reduced to show only “Power” 50″ and “Climate” 52″. Thus, the display 16″ has been adapted to an appropriate level of content (more or fewer buttons) and interface attributes (such as size, position, etc.) based upon current driving conditions.

FIGS. 2a and 2b show one representative example of a display that adapts to driving conditions in response to the received vehicle information signal 18. It is understood that the scale, type and amount of display modification that may take place based upon calculated, perceived or inferred driving conditions is virtually unlimited, and may be modified as desired. For example, a relatively simple adaptive HMI interface may only switch between one or two different visual representations of information on the displays 16′, 16″, while a complex system may continuously and adaptively modify the display to an appropriate level of content in response to certain driving conditions. On board displays that may be modified include instrument clusters, center stack electronics such as audio/infotainment, climate and GPS, and include any other display within the vehicle.

It is understood that the adaptive HMI control system 10 may also be modified as desired. For example, a relatively simple system may only have a few on-board systems 20 and off-board systems 22 to monitor, while complex systems may monitor all on-board vehicle systems 20 and a plurality of off-board systems 22. It is further understood that the control signal 26 may be adapted to be received by any display 16 of the vehicle and under any conditions, as desired. As a non-limiting example, the control signal 26 may adaptively change the instrument cluster display in response to increased speed, braking, engine temperature, fuel state, traffic conditions, GPS signals, terrain, road conditions or the like. As another example, the size of any buttons or touch screen locations may be increased to compensate for vehicle speed or rough road conditions, ambient noise, open windows, or other vehicle conditions. Thus, the control signal 26 may control any display of information in response to any vehicle condition, as desired.

The adaptive HMI control system 10 and the method for controlling the visual representation of information on a display 16 provide a convenient, user-friendly and easily accessible system for dynamically adapting a vehicle's human machine interface to its current operating conditions. The adaptive HMI control system 10 may use any combination of sensor or other real-time data available in the vehicle for adjusting the user interface. Examples of this data include: speed, acceleration, gyroscope, windshield wiper operation, light/archives, temperature, moisture, stability, and the like.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An adaptive HMI control system for a vehicle comprising:
a vehicle information system adapted to generate and transmit a vehicle information signal including data representing a vehicle condition; and
a controller adapted to receive the vehicle information signal, analyze the vehicle information signal, and generate and transmit a control signal for controlling a visual representation of data in response to the vehicle information signal.

2. The adaptive HMI control system according to claim 1, further comprising a display adapted to receive the control signal and generate a visual representation to a user in response to the control signal.

3. The adaptive HMI control system according to claim 1, wherein the controller includes a processor adapted to analyze the vehicle information signal.

4. The adaptive HMI control system according to claim 1, wherein the vehicle information signal includes information from at least one on-board system and at least one off-board system.

5. The adaptive HMI control system according to claim 4, wherein the controller includes an instruction set having processor executable instructions for configuring the processor to perform the analysis of the vehicle information signal.

6. The adaptive HMI control system according to claim 1, wherein the controller includes a storage system for storing data.

7. The adaptive HMI control system according to claim 1, wherein the controller includes a programmable component adapted to provide user-controlled management of the vehicle information system.

8. The adaptive HMI control system according to claim 1, wherein the visual representation of data is controlled to modify the display in response to driving conditions.

9. The adaptive HMI control system according to claim 8, wherein the visual representation of data is controlled to reduce an information content as driving complexity increases.

10. An adaptive HMI control system for a vehicle comprising:
a vehicle information system adapted to generate and transmit a vehicle information signal including data representing a vehicle condition;
a controller adapted to receive the vehicle information signal, analyze the vehicle information signal, and generate and transmit a control signal in response to the vehicle information signal; and
a display adapted to receive the control signal and generate a visual representation of data to a user in response to the control signal.

11. The adaptive HMI control system according to claim 10, wherein the controller includes a processor adapted to analyze the vehicle information signal.

12. The adaptive HMI control system according to claim 11, wherein the vehicle information signal includes information from at least one on-board system and at least one off-board system.

13. The adaptive HMI control system according to claim 12, wherein the controller includes an instruction set having processor executable instructions for configuring the processor to perform the analysis of the vehicle information signal.

14. The adaptive HMI control system according to claim 13, wherein the controller includes a storage system for storing data.

15. The adaptive HMI control system according to claim 10, wherein the controller includes a programmable component adapted to provide user-controlled management of the vehicle information system.

16. The adaptive HMI control system according to claim 10, wherein the visual representation of data is controlled to modify the display in response driving conditions.

17. A method for adaptively controlling a display, the method comprising the steps of:
retrieving first data representing at least one of a vehicle on-board condition and an off-board condition;
generating a vehicle information signal including the retrieved data;
analyzing the vehicle information signal;
generating a control signal in response to the vehicle information signal; and
generating a visual representation of second data on a display in response to the control signal.

18. The method according to claim 17, wherein the step of analyzing the vehicle information signal is performed by a controller adapted to receive the vehicle information signal, analyze the vehicle information signal, and generate and transmit the control signal for controlling the display.

19. The method according to claim 18, wherein the controller includes a processor adapted to analyze the vehicle information signal.

20. The method according to claim 17, wherein the visual representation of data is controlled to modify the display in response driving conditions.
